(19) United States
(12) Patent Application Publication
(10) Pub. No.: US 2008/0239905 A1
(43) Pub. Date: Oct. 2, 2008

(54) FOCUSING-ERROR DETECTING DEVICE AND HOLOGRAPHIC DATA-RECORDING/REPRODUCING APPARATUS HAVING THE DEVICE

(75) Inventors: Yuichiro Yamamoto, Tokyo (JP); Shinichi Tatsuta, Tokyo (JP); Yuji Kubota, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/047,762

(22) Filed: Mar. 13, 2008

(30) Foreign Application Priority Data
Mar. 28, 2007 (JP) 2007-086013

(51) Int. Cl. G11B 5/58

(52) U.S. Cl. 369/53.17

(57) ABSTRACT

In a device for detecting a focus error in controlling a position in an optical axis, a laser beam is split into first and second beam components, and one of the first and second beam components is diverged or converged. Then, the first and second beam components are superposed on each other, providing a single laser beam. The single laser beam is applied to an optical data-recording medium through an objective lens. The first laser beam component is focused on a first focusing point that is set at one side of the pinhole. The second beam component is focused on a second focusing point that is set at the other side of the pinhole.

### CROSS-REFERENCE TO RELATED APPLICATIONS

This application is based upon and claims the benefit of priority from prior Japanese Patent Application No. 2007-086013, filed Mar. 28, 2007, the entire contents of which are incorporated herein by reference.

### BACKGROUND OF THE INVENTION

1. Field of the Invention

The present invention relates to a focus-error detecting device and a holographic data-recording/reproducing apparatus provided with the focus-error detecting device. More particularly, the invention relates to a focus-error detecting device for use in an optical storage apparatus that records and reproduces data by means of holography.

2. Description of the Related Art

Optical disks have an ever-increasing storage capacity as the laser-beam wavelength decreases and the numerical aperture increases, thus providing first CD, then DVD and finally HD DVD. The storage capacity is now said to be approaching a limit for HD DVD and Blu-ray disk, which all use a blue-violet semiconductor laser that emits light having a wavelength of 405 nm. In view of this, a novel data-recording/reproducing system should be provided to impart a drastically large storage capacity to optical disks. In the circumstances, various systems for storing data at high density, such as volumetric recording, multilayer recording and proximity recording, are studied as high-density optical storage systems of the next-generation. In these optical storage systems, the volumetric-recording optical storage system that utilizes holography is considered promising. In recent years, experiments have been conducted, the results of which show that high-sensitivity hologram media can be developed and that the storage capacity of each medium can be increased. Therefore, research and development are proceeding to provide practical hologram media.

The principle of the volumetric-recording optical storage system utilizing holography lies in that an information beam interferes with a reference beam in an optical data-recording medium, recording the data as a minute interference pattern that is a three-dimensional pattern. A plurality of data items can be recorded at the same position or at overlapping positions in the optical data-recording medium. The optical storage system utilizing holography can store a far greater amount of data than the existing optical disks, such as HD DVD and Blu-ray disk, in which data is recorded in a plane in the form of pits or record marks.

The optical storage systems utilizing holography are classified into several multiplexing systems, such as a shift-multiplexing system, angular multiplexing system and wavelength-division multiplexing system, which are designed to enhance the data-recording density. The shift-multiplexing system changes the position of the laser beam a little, relative to the recording medium, thus recording data. The angular multiplexing system changes the angle of the laser beam, relative to the recording medium, thereby recording data. The wavelength-division multiplexing system changes the wavelength of the laser beam, thus recording data. These types of multiplexing systems may be combined into various systems for recording and reproducing data. A representative multiplexing data-recording/reproducing system is disclosed in “H. J. Coufal et al., Holographic Data Storage, Springer, 2000, (ISBN 3-5406-6691-5)”. Another type of a data-recording/reproducing system is disclosed in U.S. Pat. No. 5,483,365. In this system, the recording medium is rotated around the axis perpendicular to the incident plane and around the axis perpendicular to the medium. The system disclosed In U.S. Pat. No. 5,483,365 is called peristrophic multiplexing. A typical optical configuration for this system is shown in FIG. 1 of the specification of U.S. Pat. No. 5,483,365. The system can be simple, because its optical section has no movable components, though its drive section includes movable components.

To put the system disclosed in U.S. Pat. No. 5,483,365 to practical use, it is important to detect and control the position of the optical data-recording medium, relative to the optical system. However, no practical simple methods of detecting and controlling the position of the optical data-recording medium have hitherto been proposed. This is because the path of the light beam reflected from the recording medium and used to detect the position of the medium is inevitably bent by an angle as large as 2θ when the recording medium rotates by angle θ. As is known, if the recording medium is rotated by several degrees to ten degrees, as in angular multiplexing, the light-beam path will deviate too much, making it difficult to use the conventional method of detecting the position of the optical disk. A transmitting light beam may be utilized to detect the position of the recording medium. In this case, too, the position of the recording medium can hardly be detected because the transmitting light beam scarcely changes when the medium changes in position. Hence, novel techniques should be employed to detect and control the position of the optical data-recording medium.

### BRIEF SUMMARY OF THE INVENTION

According to a first aspect of the present invention, there is provided a focus-error detecting device comprising:

a laser-beam source which emits a focus-error detecting laser beam;

a beam-splitting optical unit which splits the focus-error detecting laser beam into a first beam component and a second beam component, which diverges or converges one of the first and second beam components and which superpose the first and second beam components to produce a single laser beam;

an objective lens which focuses the first and second beam components of the single laser beam in first and second focusing points in an optical data-recording medium, respectively, wherein the optical data-recording medium has an array of pin holes and is substantially insensitive to the first and second beam components, the first focusing point is set at one side of the pinhole, and the second focusing point is set at the other side of the pinhole;

a detection optical unit which splits the single laser beam emerged from the optical data-recording medium, into the first and second beam components, detects the first and second components to generate first and second detection signals, respectively; and

a processing unit which processes the first and second detection signals, thereby generating a focus-error signal.

According to a second aspect of the present invention, there is provided an optical data-recording/reproducing apparatuses comprising:

a recording/reproducing laser beam source which generates a recording/reproducing laser beam;

a first beam splitting unit which splits the recording/reproducing laser beam into a recording laser beam and a reference laser beam;

a focus-detecting laser beam source which generates a focus-error detecting laser beam;

a second beam splitting unit which splits the focus-error detecting laser beam into a first beam component and a second beam component, which diverges or converges one of the first and second beam components and which superpose the first and second beam components to produce a single laser beam;

an objective lens which focuses the recording laser beam on a hologram recording medium and first and second components of the single laser beam in first and second focusing points in the hologram recording medium, respectively, wherein the hologram recording medium has an array of pin holes and a recording layer which is substantially insensitive to the first and second beam components, the first focusing point is set at one side of the pinhole, and the second focusing point is set at the other side of the pinhole;

a converging optical unit which converges the reference laser beam in the recording layer, wherein the reference laser beam optically interferes with the recording laser beam to produce an interference recording pattern in a recording mode, and the reference laser beam is projected on the interference recording pattern without illumination of the recording laser beam to generate a reproducing laser beam from the interference recording pattern in a reproduction mode;

a photodetector which detects the reproducing laser beam;

a detection optical unit which splits the single laser beam emerged from the optical data-recording medium, into the first and second beam components, detects the first and second components to generate first and second detection signals, respectively; and

a processing unit which processes the first and second detection signals, thereby generating a focus-error signal.

According to the third aspect of the present invention, there is provided a method of detecting a focus error, comprising:

generating a focus-error detecting laser beam;

splitting the focus-error detecting laser beam into a first beam component and a second beam component, which diverges or converges one of the first and second beam components and which superpose the first and second beam components to produce a single laser beam;

focusing first and second components of the single laser beam in first and second focusing points in an optical data-recording medium, respectively, wherein the optical data-recording medium has an array of pin holes and is substantially insensitive to the first and second beam components, the first focusing point is set at one side of the pinhole, and the second focusing point is set at the other side of the pinhole;

splitting the single laser beam emerged from the optical data-recording medium, into the first and second beam components;

detecting the first and second components to generate first and second detection signals, respectively; and

processing the first and second detection signals, thereby generating a focus-error signal.

### BRIEF DESCRIPTION OF THE SEVERAL VIEWS OF THE DRAWING

FIG. 1 is a sectional view schematically showing the structure of an optical data-recording medium in and from which data can be recorded and reproduced by an optical data-recording/reproducing apparatus according to an embodiment of the present invention;

FIG. 2 is a perspective view schematically showing the structure of the optical data-recording medium shown in FIG. 1;

FIG. 3 is a diagram schematically showing the focus-error detecting optical system incorporated in an optical data-reproducing/reproducing apparatus according to an embodiment of this invention;

FIG. 4 is a perspective view schematically showing a two-focus forming optical system that may be incorporated in the optical data-reproducing/reproducing apparatus shown in FIG. 3;

FIG. 5 is a side view schematically showing another type of a two-focus forming optical system, which may be used in the optical data-reproducing/reproducing apparatus shown in FIG. 3;

FIGS. 6A and 6B are diagrams illustrating two laser beams, respectively, each passing through the optical data-recording medium in the focus-error detecting optical system shown in FIGS. 4 and 5;

FIGS. 7A to 7C are other diagrams illustrating laser beams, each passing through the optical data-recording medium in the focus-error detecting optical system shown in FIGS. 4 and 5;

FIG. 7D is a graph schematically showing the relation between the focus error and the output of the detector incorporated in the focus-error detecting optical system shown in FIGS. 7A to 7C;

FIGS. 8A to 8C are other diagrams illustrating laser beams, each passing through the optical data-recording medium in the focus-error detecting optical system shown in FIGS. 4 and 5;

FIG. 8D is a graph schematically showing the relation between the focus error and the output of the detector incorporated in the focus-error detecting optical system shown in FIGS. 8A to 8C;

FIG. 9 is a diagram schematically showing the focus-error detecting optical system incorporated in an optical data-reproducing/reproducing apparatus according to another embodiment of this invention;

FIG. 10 a perspective view schematically showing a two-focus forming optical system that may be used in the optical data-reproducing/reproducing apparatus shown in FIG. 9;

FIG. 11 is a side view schematically showing another type of a two-focus forming optical system that may be used in the optical data-reproducing/reproducing apparatus shown in FIG. 9;

FIG. 12 is a diagram schematically showing an optical data-reproducing/reproducing apparatus that incorporates the focus-error detecting optical system shown in FIG. 3 or FIG. 9; and

FIG. 13 is a plan view schematically showing a pinhole layer different from the pinhole layer of the optical data-recording medium shown in FIG. 1.

### DETAILED DESCRIPTION OF THE INVENTION

A focus-error detecting device according to an embodiment of the invention and a holographic data-recording/reproducing apparatus provided with the focus-error detecting device will be described, with reference to the accompanying drawings.

First, an optical data-recording medium in which data may be recorded in the holographic data-recording/reproducing apparatus will be described in terms of configuration. Then, the optical system that detects a focus error on the optical data-recording medium will be described. Further, the configuration of an optical data-recording/reproducing apparatus employing a focus-error detecting method according to this invention will be described.

[Configuration of the Optical Data-Recording Medium]

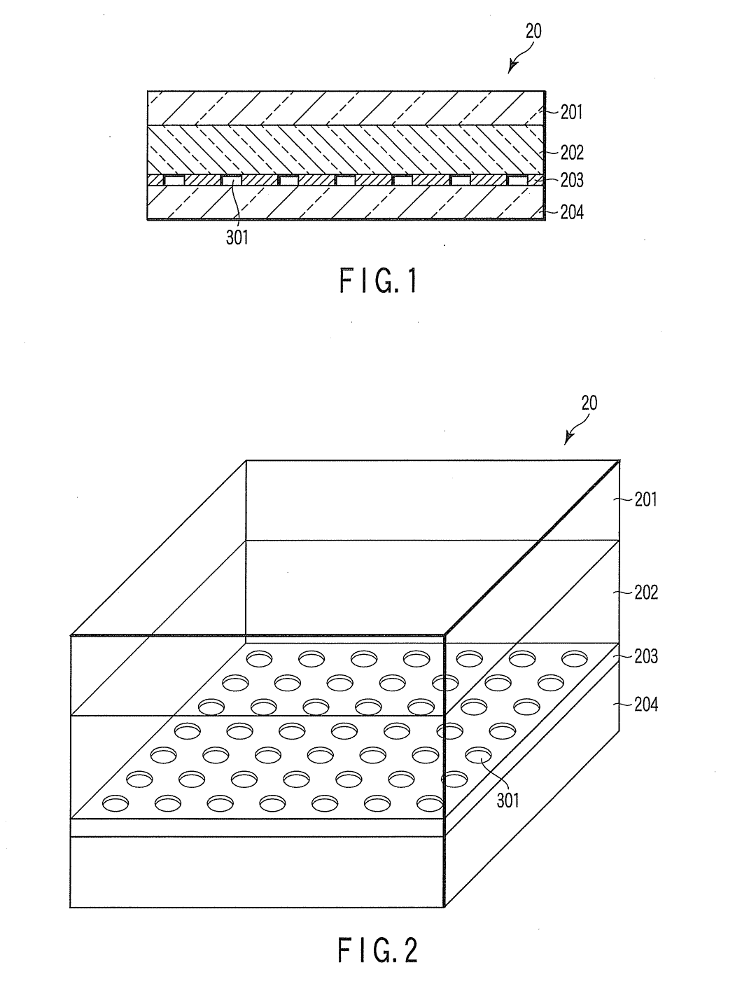

FIG. 1 is a sectional view schematically showing the structure of an optical data-recording medium in and from which data can be recorded and reproduced by an optical data-recording/reproducing apparatus according to an embodiment of the present invention. FIG. 2 is a see-through perspective view showing the structure of this optical data-recording medium. As shown in FIGS. 1 and 2, the optical data-recording medium 20 comprises an optical data-recording layer 202 and a pinhole layer 203. The pinhole layer 203 has one or more pinholes 301. The optical data-recording layer 202 is laid on the pinhole layer 203. The physical characteristic of the optical data-recording layer 202 can be optically changed, whereby an interference pattern is recorded in the layer 202. The two-layered structure constituted by the optical data-recording layer 202 and the pinhole layer 203 is held between two cover substrates 201 and 204.

The cover substrates 201 and 204 are provided for two purposes. First, they reduce the influence of the scars in, or dust on, the surfaces of the optical data-recording layer 202. Second, they hold the optical data-recording layer 202 (a gel layer, in most cases). The cover substrates 201 and 204 are made of glass, polycarbonate, PMMA or the like in most cases. They may be made of other materials if they exhibit optical characteristics appropriate to the wavelength of the laser beam used and if they have sufficient mechanical strength, sufficient dimensional stability, sufficient molding-easiness and the like. The optical data-recording layer 202 is sensitive to the recording laser beam used and is substantially non-sensitive to the focus-detecting laser beam used. More precisely, the layer 202 is a hologram medium, the representative material of which is a photopolymer. A photopolymer is a photosensitive material made by photo-polymerizing monomers. Its main components are generally monomers, a polymerization-initiating agent and a porous matrix. Note that the porous matrix maintains the volume before and after the data recording. The optical data-recording layer 202, which is a hologram medium layer, should be about 100 μm or more thick to attain a sufficient diffraction efficiency to reproduce signals and attain angular resolution required in angular multiplexing. The optical data-recording layer 202 may be a layer made of a material other than a photopolymer. It may be made of a medium that can achieve hologram recording, such as gelatin bichromate or photorefractive crystal.

As FIG. 2 shows, the pinhole layer 203 is a thin film having one or more pinholes 301. The pinholes 301 are used to generate a focus-error signal as will be described later. The pin holes 301 are provided to eliminate unnecessary diffracted light generated at the time of reproducing data and to avoid a crosstalk at the adjacent recording position (i.e., recorded region).

The pinholes 301 shown in FIG. 2 are physical apertures. They may be high-transmittance parts of a multi-layer film, the remaining parts of which have a low transmittance and scarcely allow passage of laser beams. In this case, the low-transmittance parts of the multi-layer film should preferably have a light-absorbing layer in order to shield stray light resulting from the reflected laser beam or to prevent light from reaching the optical data-recording layer 202.

[Focus-error Detecting Optical System]

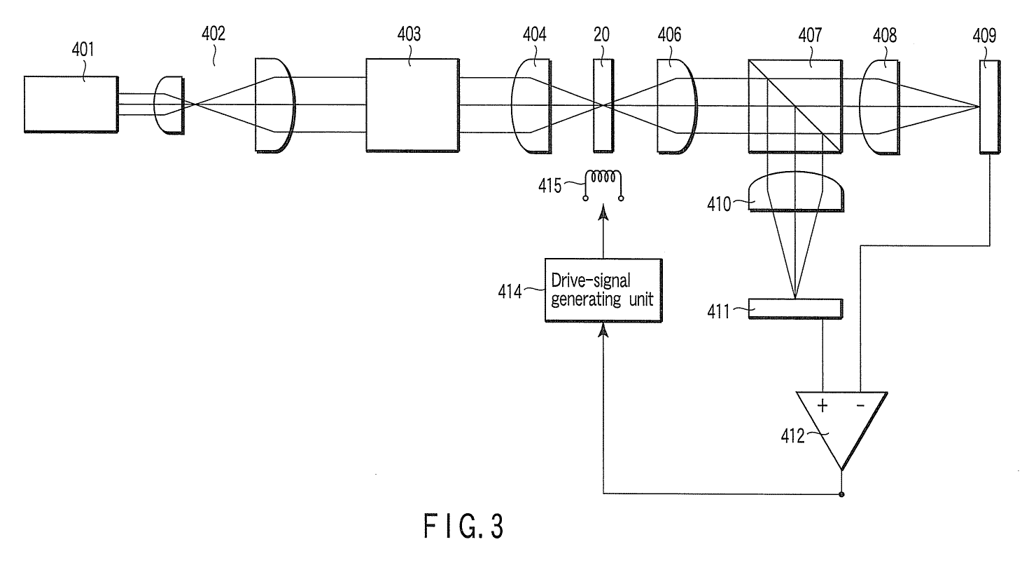

FIG. 3 shows the focus-error detecting optical system provided in the optical data-reproducing/reproducing apparatus according to this embodiment of the invention. As described above, the optical data-recording medium 20 has a pinhole layer 203 that has one or more pinholes 301.

As seen from FIG. 3, photodetectors 409 and 411 generate two detection signals, respectively. A signal representing the difference between the detection signals is input to a differential amplifier 412. The differential amplifier 412 generates a focus error signal.

Meanwhile, a focus-error detecting laser 401 emits a linearly polarized laser beam. This beam is applied to a beam-expanding optical system (collimator system) 402. The beam-expanding optical system 402 increases the diameter of the beam, changing the beam to a parallel light flux (collimated laser beam). The parallel light flux is applied to a two-focus forming optical system 403. The two-focus forming optical system 403 divides the parallel light flux into a P polarized component and an S polarized component, and diverges or converges the P polarized component or the S polarized component. The P and S polarized components are superposed on each other, providing a single laser beam. This laser beam is applied to an objective lens 404. As the P and S polarized beams are focused by the objective lens 404, one of them is diverged or converged. As a result, the P and S polarized beams can be focused at different focusing points.

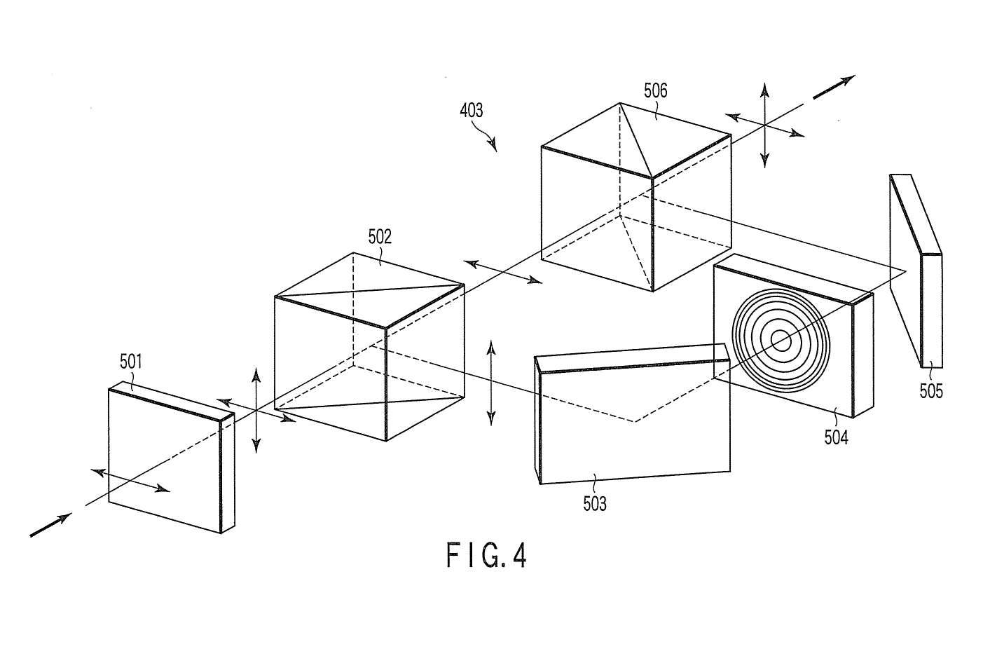

FIG. 4 shows a specific example of the two-focus forming optical system 403. In the two-focus forming optical system 403, the incident linearly polarized laser beam passes through a half-wavelength plate 501. While passing through the plate 501, the beam is converted to a beam in which the P and S polarized components have the same intensity. This laser beam is then applied to a polarized-beam splitter 502. The polarized-beam splitter 502 splits the beam into a P polarized component and an S polarized component. More specifically, the polarized-beam splitter 502 reflects one polarized component and allows the passage of the other polarized component. For simplicity of explanation, assume that the S polarized component is reflected by the splitter 502 and the P polarized component passes through the splitter 502. Then, the S polarized component reflected by the splitter 502 is reflected by a reflecting mirror 503 and applied to a diffraction gating 504. The diffraction grating 504 has the function of a concave lens and therefore converts the incident beam to a diverging beam. The diffraction gating 504 may have the function of a convex lens and may therefore convert the incident beam to a converging beam. This diffraction gating can be realized in the form of a phase-type zone plate (kinoform) that converts a primary diffracted beam to a diverging beam. As is well known, the efficiency of diffracting the primary light can be increased to almost 100% by optimizing the grooves of the grating in terms of depth. The diverged beam emerging from the diffraction gating 504 is reflected by a reflecting mirror 505 and applied to a polarized-beam splitter 506. The polarized-beam splitter 506 receives the P polarized component of the parallel light flux, too, which has passed through the polarized-beam splitter 502. At the polarizing surface of the polarized-beam splitter 506, the S and P polarized components are superposed on each other, providing a single light beam.

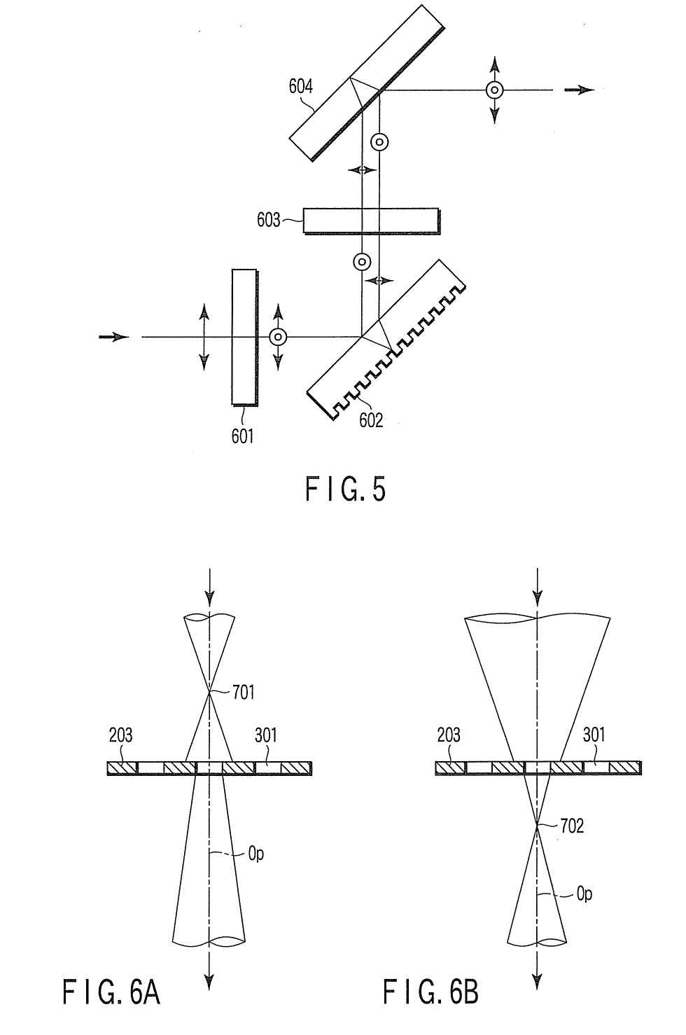

The two-focus forming optical system 403 is not limited to such an optical system as shown in FIG. 4. It may have such an optical system as shown in FIG. 5. In the optical system of FIG. 5, the parallel flux applied to the two-focus forming optical system 403, i.e., a linearly polarized laser beam, is applied to a half-wavelength plate 601. The linearly polarized laser beam is therefore converted to a circularly polarized laser beam in which the P and S polarized components have the same intensity. The circularly polarized laser beam is applied to a mirror 602 that has a diffraction grating affixed to the back. This diffraction grating is equivalent to the phase-type zone plate (kinoform) mentioned above. It has the function of converting an incident parallel laser beam to a diverging laser beam and reflecting the diverging laser beam. The mirror 602 has the function of totally reflecting the S polarized component at a surface and of allowing the passage of the P polarized component. The P polarized component that has passed through the surface of the mirror 602 is converted to a diverging laser beam, which is reflected by the diffraction grating affixed to the back of the mirror 602. The diffraction grating may convert the parallel incident laser beam to a converging laser beam, instead of a diverging laser beam as described above. Further, the mirror 602 may totally reflect the P polarized component at the front and may allow the passage of the S polarized component.

The laser beam reflected by the mirror 602 and composed of the S and P polarized components is applied to a half-wavelength plate 603. The half-wavelength plate 603 converts the S polarized component to a P polarized component, and the P polarized component to an S polarized component. The P and S polarized components output from the plate 603 are applied to a mirror 604. The mirror 604 differs from the mirror 602 only in that it has no diffraction gratings. As shown in FIG. 5, the mirror 604 totally reflects the P polarized component and the S polarized component at the front and the back, respectively. The P polarized component thus reflected at the front of the mirror 602 and the S polarized component converted to a diverging beam and reflected at the back of the mirror 602 are superposed on each other at the mirror 604, with their optical axes aligned to each other.

As shown in FIG. 3, the laser beam composed of the S and P polarized components and output from the two-focus forming optical system 403 is converged toward the objective lens 404. The objective lens 404 converges the laser beam toward the optical data-recording medium 20. In the optical data-recording medium 20, the P and S polarized components are focused at different focusing points. The P and S polarized components then emerge from the optical data-recording medium 20. As already pointed out, the optical data-recording layer 202 of the medium 20 has no sensitivity to the focus-detecting laser beam, but has sensitivity to the recording laser beam, as will be described later. Hence, the optical data-recording medium 20 can record an interference pattern formed of a data optical wave and a reference optical wave.

The diverging laser beam that has passed through the optical data-recording medium 20 is applied to an objective lens 406. The objective lens 406 converts the laser beam to a parallel beam, which is applied to a polarized-beam splitter 407. The polarized-beam splitter 407 reflects, at its polarizing plane, one of the P and S polarized components, and allows the passage of the other polarized component. As a result, two laser beams emerge from the polarized-beam splitter 407. These laser beams are focused by focusing lenses 408 and 410, respectively, and applied thence to the photodetectors 409 and 411. The photodetectors 409 and 411 generate detection signals that represent the intensities of the incident laser beams, respectively. The detection signals are supplied to the differential amplifier 412. The differential amplifier 412 generates a focus error signal. The focus error signal is supplied to a drive-signal generating unit 414, which generates a drive signal from the focus error signal. The drive signal is supplied to a drive mechanism 415, which minutely moves the medium 20 along the optical axis of the focus-error detecting optical system (FIG. 3), thereby positioning the optical data-recording layer 202 at the focusing position.

In the control system shown in FIG. 3, the drive mechanism 415 moves the medium 20 along the optical axis of the system. Instead, the drive mechanism 415 may shift the objective lenses 404 and 406 along the optical axis in accordance with the focus error signal.

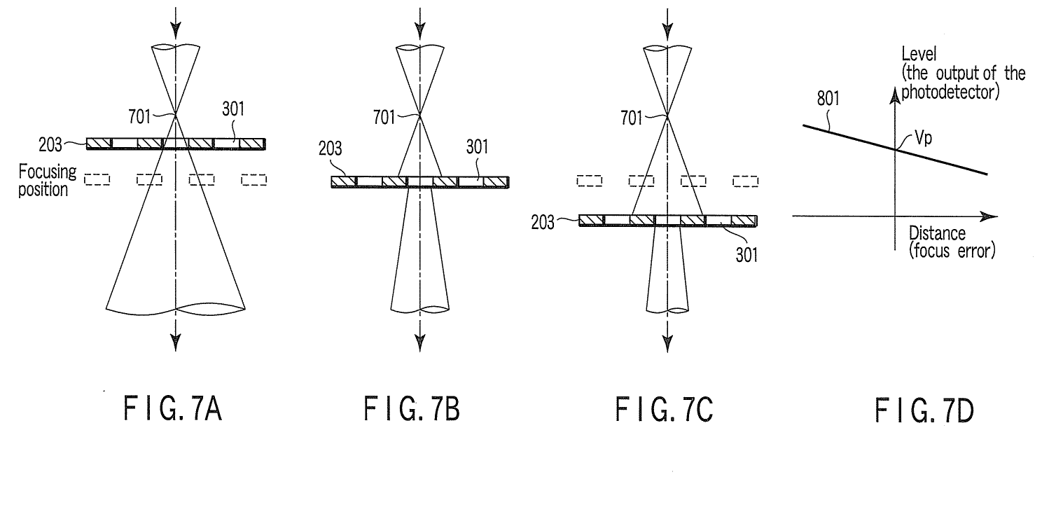

How the focus is detected in the optical system shown in FIG. 3 will be explained, with reference to FIGS. 6A and 6B and FIGS. 7A to 7D. As FIGS. 6A and 6B show, the laser beam focused by the objective lens 404 forms focusing points 701 and 702 in the optical data-recording medium 20. That is, the P and S polarized components of the laser beam are focused at different points, because one of the polarized components has been diverged or converged in the two-focus forming optical system 403. In the embodiment described above, the S polarized component is diverged in the two-focus forming optical system 403. Therefore, the P polarized component is focused by the objective lens 404 at the focusing point 701 that lies on one side of the pinhole layer 203 that is close to the light source. By contrast, the S polarized component, which has been diverged, is focused by the objective lens 404 at the focusing point 702 that lies on the other side of the pinhole layer 203 that is remote from the light source. As long as the optical axis Op of the P polarized component passes through a pinhole 301, the closer the focusing point 701 is to the pinhole 301, the more intense will be the P polarized component that passes through the pinhole 301. The farther the focusing point 701 exists from the pinhole 301, the more the P polarized component will be blocked by the pinhole layer 203 and the less intense will be the P polarized component that passes through the pinhole 301. Similarly, as long as the optical axis Op of the S polarized component passes through a pinhole 301, the closer the focusing point 702 is to the pinhole 301, the more intense will be the S polarized component that passes through the pinhole 301. The farther the focusing point 702 exists from the pinhole 301, the more the S polarized component will be blocked by the pinhole layer 203 and the less intense will be the P polarized component that passes through the pinhole 301.

Assume that the pinhole 301 lies at a midpoint between the focusing points 701 and 702 as shown in FIGS. 6A and 6B. Then, the recording laser beam is found to be focused in the optical data-recording layer 202, if the P polarized component and the S polarized component, both passed through the pinhole 301, are detected. That is, the P and S polarized components have their circumferential part blocked by the pinhole layer 203 as shown in FIGS. 6A and 6B. The P and S polarized components, each passing through the pin hole 301, are applied to the photodetectors 409 and 411 shown in FIG. 3. The photodetectors 409 and 411 can generate a detection signal each.

The pinhole 301 must have such a diameter that the P and S polarized components may have their circumferential part blocked by the pinhole layer 203. More precisely, it is desired that the pinhole 301 should have a diameter D given below:

$$D < Δ z \cdot tan ( {sin}^{- 1} ( \frac{NA}{n} ) )$$

where Δz [μm] is the difference between the distance from the objective lens 404 to the focusing point 701 of the P polarized component and the distance from the objective lens 404 to the focusing point 702 of the S polarized component, NA is the numerical aperture of the objective lens 404, and n is the average refractive index of the optical data-recording medium 20.

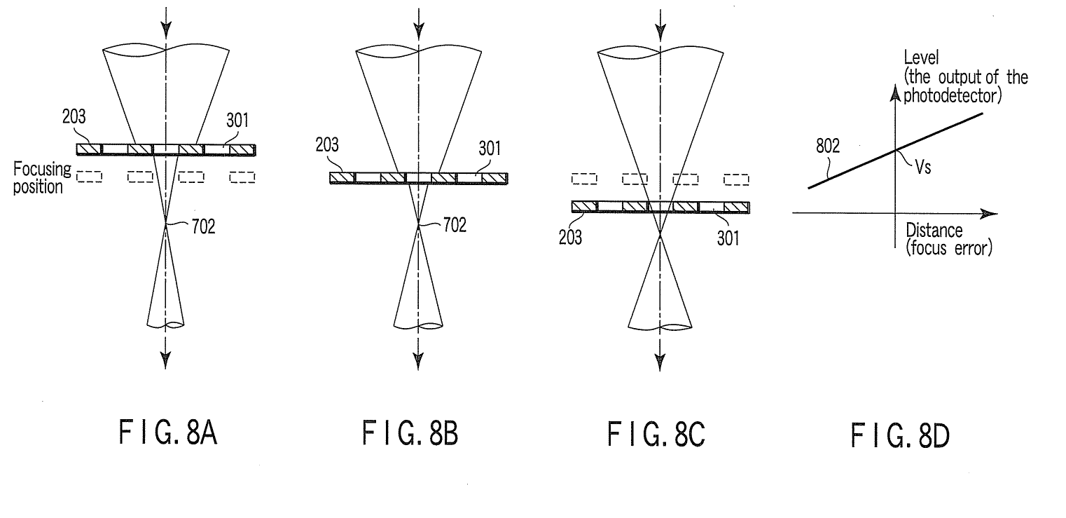

The detection signals that the photodetectors 409 and 411 generate when a focus error (a position change in the direction of the optical axis) occurs at the optical data-recording medium 20 will be explained with reference to FIGS. 7A to 7D and FIGS. 8A to 8D. FIGS. 7B and 8B show the P and S polarized components, respectively, both applied to the pinhole 301 that lies at a focusing point. The photodetectors 409 and 411, which detect the P and S polarized components, respectively, output detection signals Vp and Vs, respectively. These signals Vp and Vs are almost identical in terms of level since they are focused at the focusing points 701 and 702, respectively. Hence, the differential amplifier 412 generates a focus error signal of a zero level, showing that the P and S polarized components are both focused well.

When the pinhole 301 moves from the focusing position shown in FIGS. 7B and 8B, toward the focusing point 701 as shown in FIG. 7A and away from the focusing point 702 as shown in FIG. 8A, the differential amplifier 412 generates a focus error signal having a negative level. In FIGS. 7B and 8B, broken lines indicate the reference position for the pinhole layer 203, which corresponds to the focusing position. As FIG. 7A shows, the part of the P polarized component that is blocked by the pinhole layer 203 decreases, and the part of the P polarized component that passes through the pinhole 301 increases. The detection signal Vp generated by the photodetector 409 therefore increases in magnitude as shown in FIG. 7D. As FIG. 8A shows, the part of the S polarized component that is blocked by the pinhole layer 203, increases, and the part of the S polarized component that passes through the pinhole 301 decreases. The detection signal Vs generated by the photodetector 4409 therefore decreases in magnitude as shown in FIG. 8D. As a result, the differential amplifier 412 generates a focus error signal having a negative level.

When the pinhole 301 moves from the focusing position shown in FIGS. 7B and 8B, away from the focusing point 701 as shown in FIG. 7C and toward the focusing point 702 as shown in FIG. 8C, the differential amplifier 412 generates a focus error signal having a positive level. In FIGS. 7C and 8C, broken lines indicate the reference position for the pinhole layer 203, which corresponds to the focusing position. As FIG. 7C shows the part of the P polarized component that is blocked by the pinhole layer 203 increases, and the part of the P polarized component that passes through the pinhole 301 decreases. The detection signal Vp generated by the photodetector 409 therefore decreases in magnitude as shown in FIG. 7D. As FIG. 8C shows, the part of the S polarized component that is blocked by the pinhole layer 203 decreases, and the part of the S polarized component that passes through the pinhole 301 increases. The detection signal Vs generated by the photodetector 409 therefore increases in magnitude as shown in FIG. 8D. As a result, the differential amplifier 412 generates a focus error signal having a negative level.

As described above, the part of the P polarized component that is blocked by the pinhole layer 203 decreases as shown in FIG. 7A and the part of the P polarized component that passes through the pinhole 301 increases, if a focus error of a negative value (which results in a focus error signal having a negative level) occurs, as compared with the case where the pinhole layer 203 lies at its reference position, i.e., focusing position. Conversely, if a focus error of a positive value (which results in a focus error signal having a positive level) occurs, the part of the P polarized component that is blocked by the pinhole layer 203 increases as shown in FIG. 7C and the part of the beam that passes through the pinhole 301 decreases. Hence, the detection signal Vp generated by the photodetector 409 changes in magnitude as shown in FIG. 7D. By contrast, the part of the S polarized component that is blocked by the pinhole layer 203 increases as shown in FIG. 8A and the part of the P polarized component that passes through the pinhole 301 decreases, if a focus error of a negative value occurs. If a focus error of a positive value occurs, the part of the S polarized component that is blocked by the pinhole layer 203 decreases as shown in FIG. 8C and the part of the beam that passes through the pinhole 301 increases. In this case, the detection signal Vs generated by the photodetector 411 changes as shown in FIG. 8D, in the manner opposite to the detection signal Vp generated by the photodetector 409. Thus, a focus error signal can be generated by finding the difference between the signals output from the photodetector 409 and 411 (Vs−Vp).

The focus-error detecting method according to this invention, described above, can provide stable focus error signals even if the optical data-recording medium is rotated by about several degrees to ten degrees during the angular multiplexing. This is because the light transmitting through the medium scarcely changes in amount due to the rotation of the medium 20, resulting in virtually no offsets.

[Modification of the Focus-error Detecting Optical System]

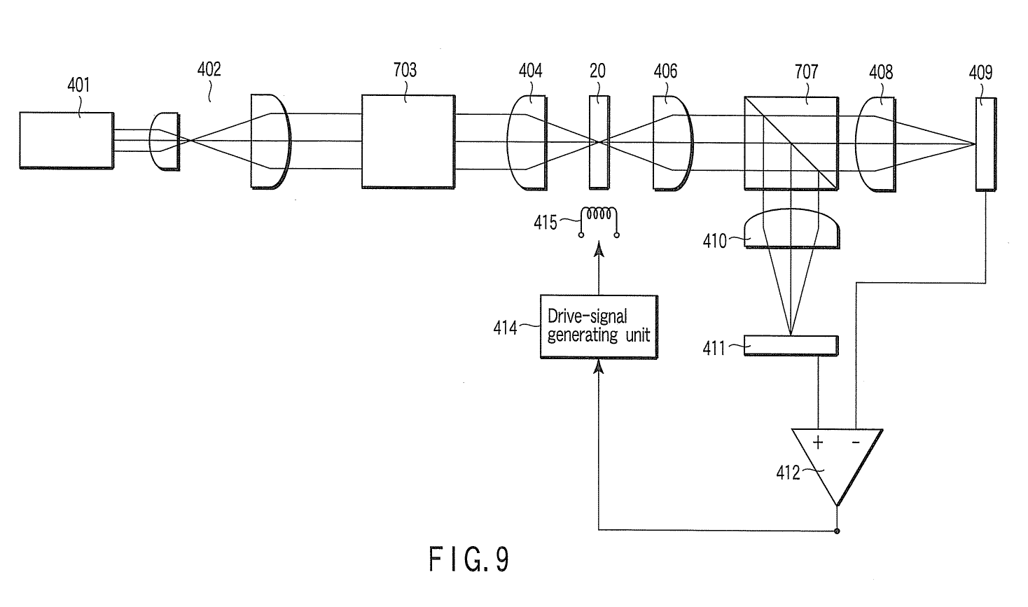

In the focus-error detecting optical system shown in FIGS. 3 to 5, the incident beam is split into a P polarized component and an S polarized component, one of the P and S polarized components is diverged or converged. The P and S polarized components are synthesized into one light beam. The light beam is focused at two focusing points 701 and 702. The focus-error detecting laser 401 may emit a laser beam that has a specified wavelength range and has peaks at first and second wavelengths λ1 and λ2. In this case, such a focus-error detecting optical system as shown in FIGS. 9 to 11 may be employed. The components shown in FIGS. 9 to 11, which are identical to those shown in FIGS. 3 to 5, are designated by the same reference numbers and will not be described in detail.

In the optical system shown in FIG. 9, a laser 401 emits a laser beam that has peaks at first and second wavelengths λ1 and λ2, and the dichroic mirror 707 is used in place of the polarized-beam splitter 407 (shown in FIG. 3).

The laser beam having peaks at first and second wavelengths λ1 and λ2 is applied from the laser 401 to a two-focus forming optical system 703. In the two-focus forming optical system 703, the incident beam is split into two beams that have wavelengths λ1 and λ2, respectively. One of these beams is diverged or converted, and both beams are synthesized into one laser beam. This laser beam is output from the two-focus forming optical system 703. The laser beam, which has first and second wavelengths λ1 and λ2, forms two focusing points 701 and 702 in the optical data-recording medium 20 in the same way as in the optical system shown in FIGS. 6A and 6B, FIGS. 7A to 7D and FIGS. 8A to 8D. The laser beam is incident on the dichroic mirror 707 that is used in place of the polarized-beam splitter 407.

The dichroic mirror 707 reflects a laser beam having wavelength λ1, which is detected by a photodetector 411. A laser beam having wavelength λ2 passes through the dichroic mirror 707 and is detected by a photodetector 409. From these laser beams the photodetectors 409 and 411 generate two detection signals, respectively. The detection signals are supplied to a differential amplifier 412. The differential amplifier 412 generates a focus error signal that represents the difference between in magnitude between the detection signals.

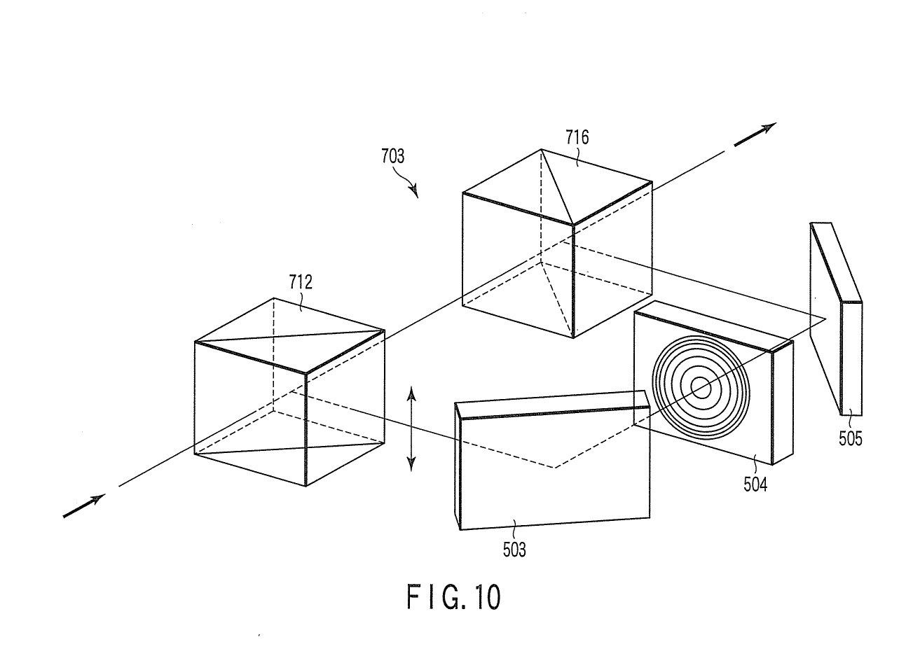

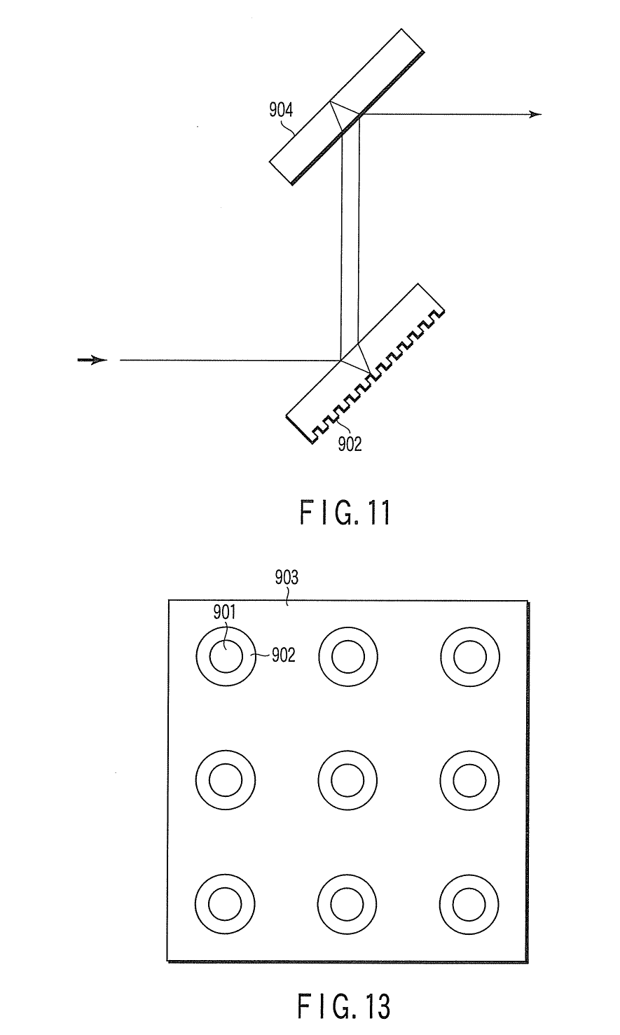

As shown in FIG. 10, the two-focus forming optical system 703 has a dichroic mirror 712 that is used in place of the polarized-beam splitter 502 (shown in FIG. 4). The dichroic mirror 712 reflects the laser beam having wavelength λ1. The laser beam having wavelength λ2 passes through the dichroic mirror 712. The laser beam having wavelength λ1 is diverged by a diffraction gating 504 and applied to a dichroic mirror 716. The dichroic mirror 716 synthesizes the laser beams having wavelengths λ1 and λ2 into a single laser beam. This laser beam is output from the two-focus forming optical system 703.

In the optical system of FIG. 10, one of the laser beams having wavelengths λ1 and λ2 is diverted or converged. A focus error can therefore be detected because of the principle explained with reference to FIGS. 7A to 7D and FIGS. 8A to 8D.

The two-focus forming optical system 403 is not limited to the optical system shown in FIG. 10. It may be such a modified optical system as is shown in FIG. 11. In the optical system of FIG. 11, a dichroic mirror 902 is used in place of the mirror 602 that has a diffraction grating affixed to the back, and similarly a dichroic mirror 904 is used in place of the mirror 604.

In the optical system shown in FIG. 11, laser beams having wavelengths λ1 and λ2 are applied to the dichroic mirror 902. The dichroic mirror 901 reflects the laser beam having wavelength λ1, which is applied to a mirror 904. The laser beam having wavelength λ2 passes through the dichroic mirror 902 and is reflected by the diffraction grating affixed to the affixed to the back of the dichroic mirror 902. The laser beam having wavelength λ2 is therefore diverged in the dichroic mirror 902. The laser beam having wavelength λ2 thus diverged is applied to the mirror 904, too. In the dichroic mirror 902, the laser beam having wavelength λ1 is reflected and the laser beam having wavelength λ2 is refracted and reflected at the back. Therefore, the laser beams having wavelengths λ1 and λ2 are synthesized into a laser beam in the mirror 904. This laser beam is applied from the two-focus forming optical system 703.

In the optical system of FIG. 11, one of the laser beams having wavelengths λ1 and λ2 is diverged or converged. Hence, the optical system can detect a focus error because of the principle explained with reference to FIGS. 7A to 7D and FIGS. 8A to 8D.

[Configuration of the Optical Data-Recording/reproducing Apparatus]

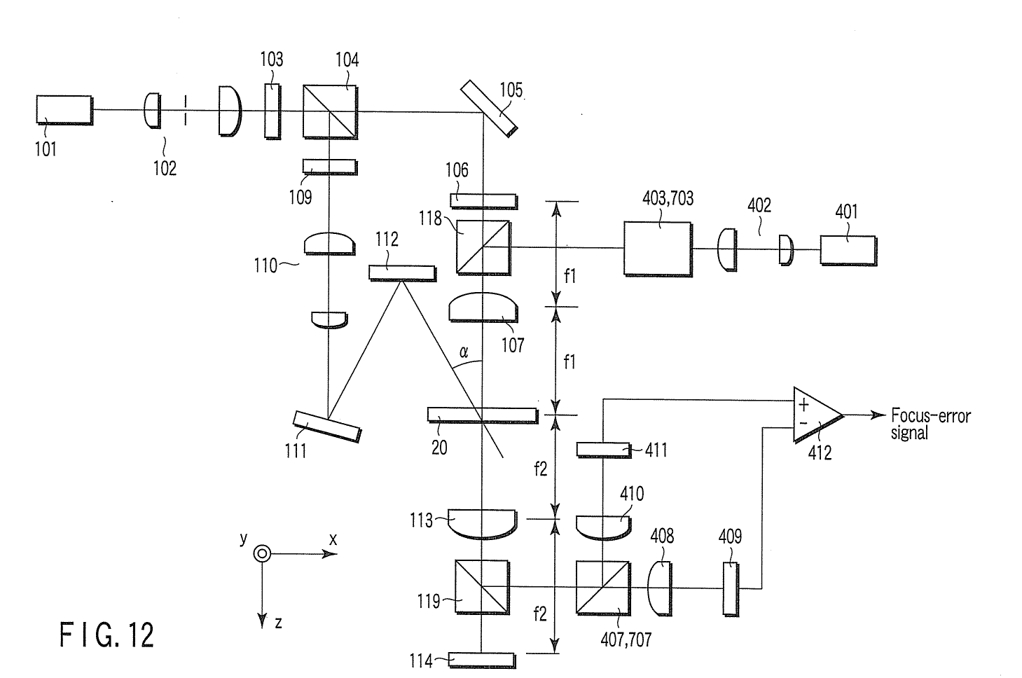

FIG. 12 shows an optical data-reproducing/reproducing apparatus that incorporates the focus-error detecting optical system shown in FIGS. 3 to 5 or the focus-error detecting optical system shown in FIGS. 9 to 11. The apparatus has a recording/reproducing optical system, in addition to the focus-error detecting optical system. The recording/reproducing optical system comprises a recording laser 101. The recording laser 101 is a single-mode laser that has a long coherence length and is therefore fit for use in hologram recording. The laser wavelength appropriate for recording-beam wavelength should be short (for example, 405 nm, i.e., the output wavelength of a blue-violet laser), in consideration of the design freedom of hologram media. The recording laser 101 emits a linearly polarized laser beam, which is applied to a spatial filtering/beam-expanding optical system 102. This optical system 102 filters noise from the linearly polarized laser beam and increases the diameter of the beam. The laser beam is applied from the optical system 102 to a half-wavelength plate 103. The half-wavelength plate 103 converts the laser beam to a laser beam having a P polarized component and an S polarized component. The beam is applied to a polarized-beam splitter 104.

The P polarized component passes through the polarized-beam splitter 104, is reflected by a mirror 105, and is applied to a special-light modulator 106. The special-light modulator 106 performs intensity modulation on the P polarized component, converting the data represented by the P polarized component into digital data. The digital data is equivalent to a binary pattern that contains an error correction code and is composed of many bright spots and dark spots. Blocks of this data are called pages or books. Hereinafter, they shall be referred to as pages. The special-light modulator 106 is a liquid crystal element. Alternatively, it may be a digital micro-mirror device (DMD) or a ferroelectric liquid crystal element. Note that ferroelectric liquid crystal elements have a high response speed of tens of microseconds.

The laser beam intensity-modulated in the special-light modulator 106 is focused by an objective lens 107 on an optical data-recording medium 20. Assume here that an electric field vibrates in a direction in the incidence plane of the optical data-recording medium 20. The laser beam is polarized in the transverse magnetic (TM) mode and is applied to the medium 20. Nonetheless, the beam may be applied to the medium 20, polarized in the transverse electric (TE) mode in which the electric field vibrates in a direction perpendicular to the incidence plane. Alternatively, the beam may be an elliptically polarized beam.

On the other hand, the S polarized component reflected by the polarized-beam splitter 104 is applied to a half-wavelength plate 109. This half-wavelength plate 109 converts the S polarized component to a P polarized beam having half the initial wavelength, which is a TM-polarized beam that can interfere with a data light beam in the optical data-recording medium 20. Then, the P polarized beam is applied to a beam-contracting system 110. The system 110 reduces the diameter of the P polarized beam. The P polarized beam with its diameter reduced is reflected first by a mirror 111 and then by a mirror 112. The P polarized beam is then applied, as a reference light beam, to the optical data-recording medium 20. In the medium 20, the P polarized beam interferes with the data light beam, whereby one-page data is recorded in the form of a minute interference pattern.

In order to enhance the angular resolution, it is desirable to increase the angle (i.e., angle α shown in FIG. 1) between the data light beam and the reference light beam. The distance between the special-light modulator 106 and a CCD 114 is defined by a 4f optical system shown in FIG. 12, in which the objective lenses 107 and 113 have focal distances f1 and f2, respectively. As shown in FIG. 12, the angular multiplexing around the Y axis and the angular multiplexing around the Z axis, and the shift multiplexing in the X and Y axes are performed, accomplishing multiplexing data-recording in a recording mode. This multiplexing data-recording is similar to the peristrophic multiplexing disclosed in U.S. Pat. No. 5,483,365.

In the data-reproducing mode, only the reference light beam is applied to the optical data-recording medium 20 in which the data is recorded in the recording mode. The primary light beam (data light) is diffracted at the reference pattern written in the medium 20, providing a two-dimensional image. The two-dimensional image is applied to a CCD 114. The CCD 114 decodes the image into digital data, thus reproducing the data. At this time, the pinhole 301 provided in the optical data-recording medium 20 serves not only to detect a focus error in the way described above, but also to eliminate unnecessary diffracted light and any crosstalk generated at adjacent recording positions.

The focus-error detecting optical system has an optical system that is similar in configuration to the system described with reference to FIGS. 3 to 5 and FIGS. 6A and 6B. A dichroic prism 118 is arranged between the special-light modulator 106 and the objective lens 107. The dichroic prism 118 allows the passage of a blue laser beam used as data-recording beam, and reflects a red laser beam used as focus-detecting beam. The dichroic prism 118 is used in the optical system shown in FIGS. 3 to 5. In the optical system shown in FIGS. 9 to 11, a half-mirror prism is used in place of the dichroic prism 118. The dichroic prism 118 or the half-mirror prism (118) guides the focus-detecting beam to the recording/reproducing optical system. In the recording/reproducing optical system, the focus-detecting beam is applied to the optical data-recording medium 20. After passing through the objective lens 113, the focus-detecting beam travels to a dichroic prism 119, which extracts a part of the beam. The extracted part of the beam is output from the recording/reproducing optical system. In the optical system shown in FIGS. 3 to 5, a dichroic prism 119 is used. In the optical system shown in FIGS. 9 to 11, a half-mirror prism is used in place of the dichroic prism 119.

As indicated above, the pinhole 301 provided in the optical data-recording medium 20 serves to detect a focus error and to eliminate noise and cross talk in the data-reproducing beam. However, the optimal diameter that the pinhole 301 should have to detect the focus error may differ from the optimal diameter it should have in order to eliminate noise and crosstalk. If this is the case, the medium 20 must have such a pinhole layer as illustrated in FIG. 13. As FIG. 13 shows, this pinhole layer comprises a light shield 903 and rings 902 formed on the light shield 903. The light shield 903 has pinholes 901, and the rings 902 surround the pinholes 901, respectively. The recording laser beam, the reproducing laser beam and the focus-error detecting laser beam can pass through each pinhole 901. The recording laser beam and the reproducing laser beam can pass through the rings 902. Preferably, the light shield 903 of the pinhole layer shown in FIG. 13 is a light-absorbing layer that shields stray light resulting from a reflected laser beam and prevents light from reaching the optical data-recording layer of the medium 20.

The recording/reproducing optical system described above is a transmission type system. The present invention is not limited to this. Obviously, a recording/reproducing optical system of a reflection coaxial-collinear type can be employed in this invention.

There can be provided a simple and yet useful focus-error detecting device for use in optical data-recording/reproducing apparatuses that can record and reproduce data in and from a rotating optical data-recording medium.

The best mode of this invention has been described. The present invention is not limited to the embodiments described above. Various changes and modifications can be made, without departing from the scope and spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A focus-error detecting device comprising:
a laser-beam source which emits a focus-error detecting laser beam;
a beam-splitting optical unit which splits the focus-error detecting laser beam into a first beam component and a second beam component, which diverges or converges one of the first and second beam components and which superpose the first and second beam components to produce a single laser beam;
an objective lens which focuses the first and second beam components of the single laser beam in first and second focusing points in an optical data-recording medium, respectively, wherein the optical data-recording medium has an array of pin holes and is substantially insensitive to the first and second beam components, the first focusing point is set at one side of the pinhole, and the second focusing point is set at the other side of the pinhole;
a detection optical unit which splits the single laser beam emerged from the optical data-recording medium, into the first and second beam components, detects the first and second components to generate first and second detection signals, respectively; and
a processing unit which processes the first and second detection signals, thereby generating a focus-error signal.

2. The device according to claim 1, wherein the beam-splitting optical unit includes a first polarized-beam splitter, splits the focus-error detecting laser beam into P and S polarized components corresponding to the first and second beam components, respectively, and superposes the P and S polarized components on each other to produce the single laser beam, the detection optical unit includes a second polarized-beam splitter and first and second detectors, the second polarized-beam splitter splits the single laser beam into P and S polarized components corresponding to the first and second beam components, respectively, and the first and second detectors detects the P and S polarized components, respectively.

3. The device according to claim 1, wherein one of the pinholes has a diameter D given below:
$$D < Δ z \cdot tan ( {sin}^{- 1} ( \frac{NA}{n} ) )$$
where Δz [μm] is the difference between the first and second focusing points, NA is the numerical aperture of the objective lens, and n is the average refractive index of the optical data-recording medium.

4. The device according to claim 1, wherein the beam-splitting optical unit includes a dichroic mirror, splits the focus-error detecting laser beam into first and second wavelength components corresponding to the first and second beam components, respectively, and superposes the first and second wavelength components on each other to produce the single laser beam, the detection optical unit includes a second dichroic mirror and first and second detectors, the second dichroic mirror splits the single laser beam into first and second wavelength components corresponding to the first and second beam components, respectively, and the first and second detectors detect the first and second wavelength components, respectively.

5. An optical data-recording/reproducing apparatuses comprising:
a recording/reproducing laser beam source which generates a recording/reproducing laser beam;
a first beam splitting unit which splits the recording/reproducing laser beam into a recording laser beam and a reference laser beam;
a focus-detecting laser beam source which generates a focus-error detecting laser beam;
a second beam splitting unit which splits the focus-error detecting laser beam into a first beam component and a second beam component, which diverges or converges one of the first and second beam components and which superpose the first and second beam components to produce a single laser beam;
an objective lens which focuses the recording laser beam on a hologram recording medium and first and second components of the single laser beam in first and second focusing points in the hologram recording medium, respectively, wherein the hologram recording medium has an array of pin holes and a recording layer which is substantially insensitive to the first and second beam components, the first focusing point is set at one side of the pinhole, and the second focusing point is set at the other side of the pinhole;
a converging optical unit which converges the reference laser beam in the recording layer, wherein the reference laser beam optically interferes with the recording laser beam to produce an interference recording pattern in a recording mode, and the reference laser beam is projected on the interference recording pattern without illumination of the recording laser beam to generate a reproducing laser beam from the interference recording pattern in a reproduction mode;
a photodetector which detects the reproducing laser beam;
a detection optical unit which splits the single laser beam emerged from the optical data-recording medium, into the first and second beam components, detects the first and second components to generate first and second detection signals, respectively; and
a processing unit which processes the first and second detection signals, thereby generating a focus-error signal.

6. The device according to claim 5, wherein the second beam splitting unit includes a first polarized-beam splitter, splits the focus-error detecting laser beam into P and S polarized components corresponding to the first and second beam components, respectively, and superposes the P and S polarized components on each other to produce the single laser beam, the detection optical unit includes a second polarized-beam splitter and first and second detectors, the second polarized-beam splitter splits the single laser beam into P and S polarized components corresponding to the first and second beam components, respectively, and the first and second detectors detects the P and S polarized components, respectively.

7. The device according to claim 1, wherein one of the pinholes has a diameter D given below:
$$D < Δ z \cdot tan ( {sin}^{- 1} ( \frac{NA}{n} ) )$$
where Δz [μm] is the difference between the first and second focusing points, NA is the numerical aperture of the objective lens, and n is the average refractive index of the optical data-recording medium.

8. The device according to claim 1, wherein the second beam splitting unit includes a dichroic mirror, splits the focus-error detecting laser beam into first and second wavelength components corresponding to the first and second beam components, respectively, and superposes the first and second wavelength components on each other to produce the single laser beam, the detection optical unit includes a second dichroic mirror and first and second detectors, the second dichroic mirror splits the single laser beam into first and second wavelength components corresponding to the first and second beam components, respectively, and the first and second detectors detect the first and second wavelength components, respectively.

9. A method of detecting a focus error, comprising:
generating a focus-error detecting laser beam;
splitting the focus-error detecting laser beam into a first beam component and a second beam component, which diverges or converges one of the first and second beam components and which superpose the first and second beam components to produce a single laser beam;
focusing first and second components of the single laser beam in first and second focusing points in an optical data-recording medium, respectively, wherein the optical data-recording medium has an array of pin holes and is substantially insensitive to the first and second beam components, the first focusing point is set at one side of the pinhole, and the second focusing point is set at the other side of the pinhole;
splitting the single laser beam emerged from the optical data-recording medium, into the first and second beam components;
detecting the first and second components to generate first and second detection signals, respectively; and
processing the first and second detection signals, thereby generating a focus-error signal.

10. The method according to claim 9, wherein, in splitting the first and second beam components, the first and second beam components correspond to P and S polarized components, respectively, and the P and S polarized components are superposed, providing a single laser beam; in detecting the first and second beam components, the single laser beam is split into the P and S polarized components which correspond to the first and second beam components, respectively, thereby detecting the P and S polarized components.

11. A hologram recording medium for a data-recording/reproducing apparatus which generates a focus-error detecting laser beam, a recording laser beam and a reference laser beam, the hologram recording comprising:
a pinhole layer having an array of pinholes;
a recording layer formed on the pinhole layer, which is substantially insensitive to the first and second beam components, and in which an interference pattern resulting from interference of a recording laser beam and a reference laser beam.
